(19) United States
(12) Patent Application Publication
(10) Pub. No.: US 2008/0244750 A1
(43) Pub. Date: Oct. 2, 2008

(54) Method and Apparatus Regarding Attachments to E-mails

(76) Inventor: Benjamin Romero, Edison, NJ (US)

Correspondence Address: Walter J. Tencza Jr., Suite 210, 100 Menlo Park, Edison, NJ, 08837, US

(21) Appl. No.: 11/692,372

(22) Filed: Mar. 28, 2007

(51) Int. Cl. G06K 9/00

(52) U.S. Cl. 726/26

(57) ABSTRACT

A computer processor is programmed by computer software so that the computer processor scans text of a first e-mail for any one of a set of matching words and if any one of the set of matching words is found in the text of the first e-mail, the computer processor is programmed by the computer software to alert a user that an e-mail attachment is missing. The set of matching words may include “attach”. The computer processor may alert a user than an e-mail attachment is missing by causing a message to be displayed on a computer monitor concerning whether an attachment should have been included with the first e-mail. The message may provide a prompt to the user which can be selected by the user to start the process of including an attachment with the first e-mail.

### FIELD OF THE INVENTION

This invention relates to improved methods and apparatus concerning electronic mails (e-mails).

### BACKGROUND OF THE INVENTION

There are various computer software programs known in the prior art for processing of electronic correspondence, or electronic mails (e-mails). Some of these programs can reside in a local computer, such as Microsoft™ Outlook™, Mozilla™ Thunderbird™, IBM™ Lotus Notes™, and others can be used via the internet such as Yahoo Mail™, Google Mail™ and others. These computer software programs are typically run by or on a computer, computer processor, or computer server. The capabilities of these computer software programs vary greatly but have basic aspects in common. These computer software programs typically allow a user to write, reply to, forward, and archive e-mails, among other operations. The ability to attach, or include files with these emails allows the user to distribute photographs and diverse amounts of electronic files. The process of attaching emails has been standardized in most if not all of these computer software programs. A common occurrence is for a sender of an e-mail to forget to attach a file after a message has been completed. Often times, especially in a business setting, the sender is very focused on the body of the message which distracts the sender after the message has been completed.

### SUMMARY OF THE INVENTION

At least one embodiment of the present invention provides a great benefit to email users by providing them with a robust solution for preventing the common occurrence of sending an email without an attachment. In a world where emails and electronic files are ubiquitous, it is imperative to provide users with automated and streamlined software solutions that improve the tasks relating to electronic communication. Sending an email and forgetting to include an attachment has become a problematic issue that hinders the user's efficiency, yields an appearance lacking professionalism and attention to detail, and which clogs computer systems with duplicate messages. Email users find themselves re-sending emails because they forgot the attachment, or recipients of email find themselves having to remind the sender to include the attachment. Software companies have neglected to identify and address this issue, while the obvious challenge is for software to be able to predict when a user wants to include an attachment and when the user does not. One or more embodiments of the present invention address this problem elegantly by allowing the user the option of scanning outgoing emails searching for specific key words that allow a processor running computer software to make an educated guess that the user intended to include an attachment. Such key words may include “attachments”, “attached”, “included”, “file”, “attach”, etc. Another feature of the computer software may be to allow the user to add or remove words, so as to allow the computer software to adapt to a user's style or preferences. A very small number of ‘false positives’ would be expected, however the benefits of the software would far outweigh any minor shortcomings.

### BRIEF DESCRIPTION OF THE DRAWINGS

FIG. 1 shows a diagram of an apparatus in accordance with an embodiment of the present invention; and

FIG. 2 shows a flow chart of a method for using the apparatus of FIG. 1 in accordance with an embodiment of the present invention.

### DETAILED DESCRIPTION OF THE DRAWINGS

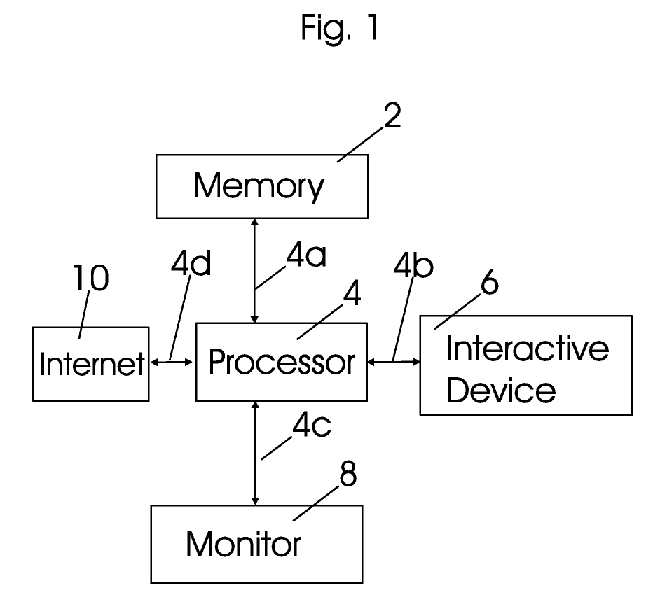

FIG. 1 shows a diagram of an apparatus 1 in accordance with an embodiment of the present invention. The apparatus 1 is comprised of a memory 2, a processor 4, an interactive device 6, a display 8, and the internet 10. The memory 2, the interactive device 6, the display 8, and the internet 10 are connected to the processor 4 by communications lines 4a, 4b, 4c, and 4d respectively. The memory 2 may be comprised of a computer memory. The processor 4 may be comprised of a computer processor. The interactive device 6 may be comprised of a computer keyboard and a computer mouse. The display 8 may be comprised of a computer monitor. Apparatus 1 is a basic representation of a networked connected, or internet connected modern computer system, or Personal Computer (PC). Most of today's computers are able to receive and deliver emails via a variety of means.

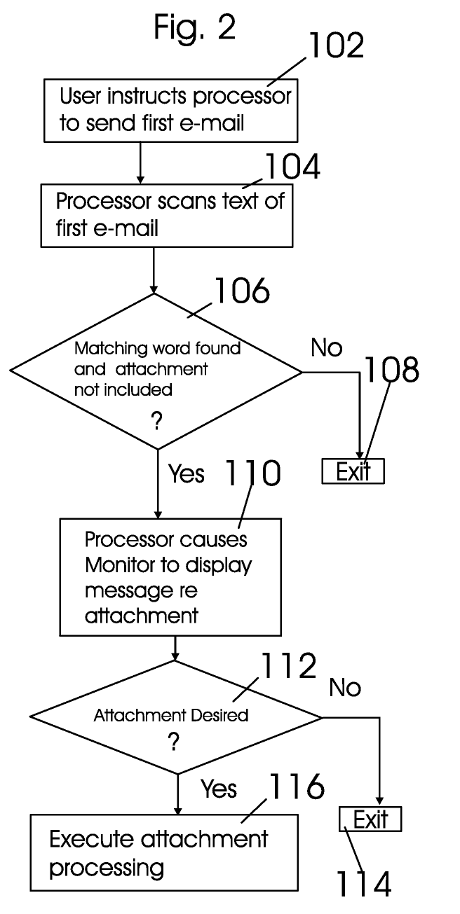

The processor 4 may be controlled by a computer software program, which implements a method in accordance with an embodiment of the present invention. FIG. 2 shows a flow chart of a method 100 for using the apparatus 1 of FIG. 1 in accordance with an embodiment of the present invention. The method 100 can be implemented by a computer software program running on the processor 4.

At step 102, a user can instruct the processor 4 to send a first electronic mail (e-mail) from the processor 4 to the internet 10, or to a remote computer server. At step 104, the processor 4 scans the text (which may include the e-mail's body and subject or any other text field) of the first e-mail to determine if the first e-mail contains certain keywords such as “attachment”, “attach” or “file”. The presence of one of these keywords indicates that the user most likely intended to attach a file or some other attachment. The list of keywords can be user customized to add or remove keywords. At step 106 if a matching word such as “attachment” is found in the text of the first e-mail, and an attachment has not been included with the e-mail, then the process continues at step 110. Otherwise, the procedure is exited at step 108; typically, this would mean that the email would follow a standard delivery process, for example moving the email to an outbox or sending the email.

It should be noted that, in another embodiment, the processor 4 can be programmed by a computer software program to scan text within an email prior to the user instructing the software program to send such email, so as to save time. In this case step 104 would occur prior to step 102, and the process would continue as described from step 106.

Another user selectable feature of the software would be to allow the scanning of only the new text when replying or forwarding a previous email. In this manner, if the user receives an email with an attachment, and presumably a matching word is present within that email's body, if the email program includes the original text with the reply or forward action, it will not be scanned if the user chooses not to do so; with this option selected, only the new text would be scanned and the original text, or thread, would not be scanned.

At step 110 the processor 4 causes the monitor 8 to display a message regarding the attachment. The message may ask the user if the user wants to include an attachment. The user may need to click “yes” or “no” fields or buttons to indicate whether the user wants to include an attachment. Additionally, instead of the “yes” option, the user could be given the option of directly browsing the system to locate a file to attach. At step 112, if the user clicks “no”, then the procedure is exited at step 114 and the e-mail is sent without an attachment. If the user clicks “yes”, then the attachment processing which is normally executed when an “attachment” button or field on a program such as “Microsoft”™ Outlook™, is executed at step 116. For example, attachment processing may include displaying a directory list of files which can then be attached.

Although the invention has been described by reference to particular illustrative embodiments thereof, many changes and modifications of the invention may become apparent to those skilled in the art without departing from the spirit and scope of the invention. It is therefore intended to include within this patent all such changes and modifications as may reasonably and properly be included within the scope of the present invention's contribution to the art.

Such a change or modification may include that a software program providing the benefits disclosed, could be built in within a main email software program, such as Microsoft™Outlook™ or be a stand alone or plug-in software running along side the email software program. In addition, the email software program and/or the plug-in software program could also be running via an internet browser through the internet or other computer network.

I claim:

1. An apparatus comprising:
a computer processor;
wherein the computer processor is programmed by computer software so that the computer processor scans text of a first e-mail for a set comprised of one or more matching words and if the set is found in the text of the first e-mail, the computer processor is programmed by the computer software to alert a user that an e-mail attachment may be missing.

2. The apparatus of claim 1 wherein
the set is comprised of at least one matching word.

3. The apparatus of claim 1 wherein
the set is comprised of at least two matching words.

4. The apparatus of claim 1 wherein
the set includes the word “attach”.

5. The apparatus of claim 1 wherein
the computer processor alerts a user that an e-mail attachment is missing by causing a message to be displayed on a computer monitor concerning whether an attachment should have been included with the first e-mail.

6. The apparatus of claim 5 wherein
the message provides a prompt to the user which can be selected by the user to start the process of including an attachment with the first e-mail.

7. The apparatus of claim 1 wherein
the computer processor is programmed by the computer software so that the computer processor scans only a new set of text in the first e-mail;
wherein the first e-mail includes one or more previous e-mails and the new set of text; and
wherein the new set of text was not in the one or more previous e-mails.

8. The apparatus of claim 1 further comprising
an interactive device;
and wherein the computer processor is programmed by the computer software to allow a user to input the set via the interactive device.

9. A method comprising the steps of
scanning text of a first e-mail for a set comprised of one or more matching words;
and if the set is found in the text of the first e-mail, alerting a user that an e-mail attachment is missing.

10. The method of claim 9 wherein
the set is comprised of at least one matching word.

11. The method of claim 9 wherein
the set is comprised of at least two matching words.

12. The method of claim 9 wherein
the set includes the word “attach”.

13. The method of claim 9 wherein
the computer processor alerts a user that an e-mail attachment is missing by causing a message to be displayed on a computer monitor concerning whether an attachment should have been included with the first e-mail.

14. The method of claim 13 wherein
the message provides a prompt to the user which can be selected by the user to start the process of including an attachment with the first e-mail.

15. The method of claim 9 wherein
only a new set of text in the first e-mail is scanned;
wherein the first e-mail includes one or more previous e-mails and the new set of text; and
wherein the new set of text was not in the one or more previous e-mails.

16. The method of claim 9 further comprising
allowing a user to input the set via an interactive device.
